(19) United States
(12) Patent Application Publication
(10) Pub. No.: US 2007/0275849 A1
(43) Pub. Date: Nov. 29, 2007

(54) Catalyst For Gaseous Partial Oxidation Of Propylene And Method For Preparing The Same

(76) Inventors: Hyun Jong Shin, Chulranam-Do (KR); Byung Yul Choi, Seoul (KR); Yeon Shick Yoo, Jeollanam-do (KR); Young Hyun Choe, Chulranam-Do (KR); Jung Hwa Kang, Seoul (KR); Min Ho Kil, Pusan (KR); Joo Yeon Park, Chulranam-Do (KR); Kwang Ho Park, Daejeon (KR); Won Ho Lee, Daejeon (KR)

Correspondence Address: CANTOR COLBURN, LLP, 55 GRIFFIN ROAD SOUTH, BLOOMFIELD, CT, 06002, US

(21) Appl. No.: 10/575,665

(22) PCT Filed: Oct. 14, 2003
(86) PCT No.: PCT/KR03/02115

§ 371 Date: Aug. 22, 2007

(51) Int. Cl. B01J 23/16

(52) U.S. Cl. 502/151; 502/150; 502/167; 502/202; 502/205; 502/207; 502/212; 502/213; 502/241; 502/242; 502/250; 502/251; 502/258; 502/259; 502/300; 502/304; 502/306; 502/307; 502/309; 502/310; 502/311

(57) ABSTRACT

The present invention relates to a method for preparing a catalyst which is used in a process of producing acrolein and acrylic acid by the reaction of oxygen-containing gas and propylene. According to the present invention, a sublimable material, such as urea (NH₂CONH₂), melamine (C₃H₆N₆), ammonium oxalate (C₂H₈N₂O₄), methyl oxalate (C₄H₆O₄) or naphthalene (C₁₀H₈), is added as a catalyst additive in the preparation of the catalyst. Using the catalyst prepared by the present invention, acrolein and acrylic can be produced at high yield.

### TECHNICAL FIELD

The present invention relates to a method for preparing a catalyst with high specific surface area to produce acrolein and acrylic acid with high yield.

### BACKGROUND ART

Until now, many documents have proposed various methods for producing acrolein, acrylic acid and other byproducts, such as acetic acid, carbon monoxide and carbon dioxide, by reacting propylene with oxygen-containing gas or air in the presence of catalysts. Most of these catalysts have been prepared and formed with the addition of ammonium nitrate, cellulose, starch, polyvinyl alcohol, stearic acid, forming aids, reinforcing agents, glass fiber, whisker, ethylene glycol or polyethylene glycol in a forming process thereof. In addition, many studies on the density, workability and specific surface area of catalysts have been conducted, and thus, many patent applications were filed in regard to the technologies on catalyst preparations and additives.

Japanese Patent Laid-open Publication No. Sho 57-119837, Japanese Patent Laid-open Publication No. Hei 1-293389, Japanese Patent Laid-open Publication No. Hei 12-16961 and Japanese Patent Laid-open Publication No. 12-325795 disclose methods for preparing catalysts by adding an organic polymer compound with a size of 0.01-10 μm to a catalyst composition of Mo—Bi—Fe—Co—Ni, and forming the mixture into a given shape, and then calcining the formed catalyst composition. Examples of the organic polymer compound added include methyl polymetacrylate, isobutyl polymetacrylate, and polystyrene. Furthermore, Japanese Patent Laid-open Publication No. Hei 13-48817 discloses a method for preparing a catalyst with enhanced durability by the addition of inorganic fiber and various whiskers to improve strength and powdering of the catalyst, and a powder binder such as ammonium nitrate, cellulose, starch, polyvinyl alcohol or stearic acid to reproduce catalyst properties. However, a need for studies on the preparation of catalysts with higher activity and production yield still exists.

Studies on the preparation of acrolein and acrylic acid using molybdenum-bismuth-cobalt-iron oxide catalysts have been highly developed.

However, in order to prepare a catalyst exhibiting higher activity and selectivity, there is a continued need for the development of methods for preparing oxide catalysts containing molybdenum-bismuth-cobalt-iron and other transition metals.

### DISCLOSURE OF THE INVENTION

An object of the present invention is to develop a catalyst capable of producing acrolein and acrylic acid at high yields, and thus to provide a catalyst which exhibits high activity for propylene oxidation, has high selectivity to acrolein and acrylic acid, and allows stable operation of a plant. To achieve this object, the present invention provides a catalyst with high specific surface area prepared by using a catalyst additive.

The present inventors have found that, in the preparation of a catalyst which contains a composite metal oxide as a catalytic active component and is used in producing acrylic acid or acrolein by the vapor-phase oxidation of propylene with oxygen-containing gas or air, the use of a sublimable material, such as urea, melamine, ammonium oxalate, methyl oxalate or naphthalene, as a catalyst additive, can provide a catalyst with high specific surface area.

On the basis of this finding, in one aspect, the present invention provides a composition for catalyst preparation comprising: 1) a composite metal oxide as a catalytic active component; and 2) at least one catalyst additive selected from the group consisting of sublimable materials, including urea (NH₂CONH₂), melamine (C₃H₆N₆), ammonium oxalate (C₂H₈N₂O₄), methyl oxalate (C₄H₆O₄) and naphthalene (C₁₀H₈).

In another aspect, the present invention provides a catalyst having fine pores formed by removing the catalyst additive from the composition for catalyst preparation by a calcining process, the catalyst additive being selected from the group consisting of sublimable materials, including urea (NH₂CONH₂), melamine (C₃H₆N₆), ammonium oxalate (C₂H₈N₂O₄), methyl oxalate (C₄H₆O₄) and naphthalene (C₁₀H₈).

In still another aspect, the present invention provides a method for preparing a catalyst containing a composite metal oxide as a catalytic active component, the method comprising the steps of:

a) preparing a catalyst suspension containing salt of each metal component of the composite metal oxide for catalytic active component;

b) drying the catalyst suspension and then crushing the dried material to prepare a catalyst powder;

c) mixing the catalyst powder with at least one catalyst additive selected from the group consisting of sublimable materials, including urea (NH₂CONH₂), melamine (C₃H₆N₆), ammonium oxalate (C₂H₈N₂O₄), methyl oxalate (C₄H₆O₄) and naphthalene (C₁₀H₈); and

d) calcining the mixture from the step c).

In further another aspect, the present invention provides a catalyst as well as a preparing method thereof, which comprises the steps of: adding at least one catalyst additive selected from the group consisting of sublimable materials, including urea (NH₂CONH₂), melamine (C₃H₆N₆), ammonium oxalate (C₂H₈N₂O₄), methyl oxalate (C₄H₆O₄) and naphthalene (C₁₀H₈) to the catalytic active component represented by the following formula 1 then mixing; forming the mixture into a given shape; and calcining the formed mixture:
MoₐBi_{b}A_{c}B_{d}CₑD_{f}E_{g}Oₙ [Formula 1]

wherein Mo is molybdenum;

Bi is bismuth;

A is an iron element;

B is at least one element selected from the group consisting of Co and Ni;

C is at least one element selected from the group consisting of W, Si, Al, Zr, Ti, Cr, Ag and Sn;

D is at least one element selected from the group consisting of P, Te, As, B, Sb, Ce, Nb, Pb, Mn, Zn and Nb;

E is at least one element selected from the group consisting of Na, K, Li, Rb, Cs, Ta, Ca and Mg;

a, b, c, d, e, f and g represent atomic ratio of the respective elements, and when a is 12, b is then 0.01-10, c is 0.01-10, d is 0.01-10, e is 0.01-10, f is 0.01-20 and g is 0.01-10, and h is a numeral value depending on the oxidation state of each of the elements.

The catalyst prepared using catalytic active component of formula 1 can be used in producing acrolein and acrylic acid by the vapor-phase contact oxidation of propylene.

Hereinafter, the present invention will be described in detail.

The catalyst conventionally prepared for the production of acrylic acid and acrolein, which consists of a composite metal oxide, is known to have low specific surface area. Because such a catalyst has low contact area with reactants and thus has low catalytic activity, it is difficult to achieve high preparation efficiency with this catalyst. To solve this problem, in the present invention, a sublimable material, such as urea, melamine, ammonium oxalate, methyl oxalate or naphthalene, was used to facilitate the control of catalyst specific surface area and to achieve high catalyst activity.

In the present invention, at least one catalyst additive selected from the group consisting of sublimable materials, including urea, melamine, ammonium oxalate, methyl oxalate and naphthalene, is added to the catalytic active component of formula 1 in the preparation of the catalyst, which is used in a process of producing acrolein and acrylic acid from, for example, oxygen-containing gas and propylene. This can provide a catalyst with high activity as a result of an increase in the specific surface area of the catalyst.

The sublimable material, such as urea, melamine, ammonium oxalate, methyl oxalate or naphthalene, is a material for controlling the surface area and fine pores of the catalyst, because it takes a certain volume in the composition for catalyst preparation and then is removed by a drying or calcining process. The sublimable material preferably has a size of 0.01-10 μm, and may be used in any form, such as granular powder or liquid phase.

The sublimable material may be used at the amount of 0.1-30% by weight to the weight of the catalytic active component of formula 1, and in view of the durability and performance of the catalyst, it may preferably be used at the amount of 0.1-20% by weight.

The sublimable material, such as urea, melamine, ammonium oxalate, methyl oxalate or naphthalene, is an organic material or organic amine consisting mainly of oxygen, nitrogen, carbon and hydrogen, and is preferably in the form of granule or powder at room temperature.

According to the present invention, the composition for catalyst preparation comprising: 1) a composite metal oxide as a catalytic active component; and 2) a catalyst additive selected from sublimable materials, including urea (NH₂CONH₂), melamine (C₃H₆N₆), ammonium oxalate (C₂H₈N₂O₄), methyl oxalate (C₄H₆O₄) and naphthalene (C₁₀H₈); is preferably calcined at a temperature of 400-500° C. for at least 5 hours to prepare a calcined final catalyst.

The catalyst additive selected from sublimable materials, including urea (NH₂CONH₂), melamine (C₃H₆N₆), ammonium oxalate (C₂H₈N₂O₄), methyl oxalate (C₄H₆O₄) and naphthalene (C₁₀H₈), is removed from the composition at a temperature below 250° C.

In addition to the above calcining step, a calcining step as a pre-treatment may be additionally adopted. That is, before the sublimable material, such as urea, melamine, ammonium oxalate, methyl oxalate or naphthalene, is added to the crushed catalyst powder, the crushed catalyst powder is calcined at 180-250° C. under an oxygen atmosphere for 3-5 hours. This pre-treatment step is conducted in order to remove hygroscopic nitrate compounds before the catalyst forming step of forming catalyst mixture into a given shape, thus making good workability.

The catalyst powder to which the catalyst additive will be added is crushed to a size of less than 150 μm for use.

The shape of the catalyst is not limited and may be any shape, such as a cylinder, sphere, pellet, ring shape, or the like.

The catalyst prepared by the method of the present invention can be used in the vapor-phase oxidation of propylene according to a conventional method without specific limitations.

### BEST MODE FOR CARRYING OUT THE INVENTION

The present invention will now be described in detail by the following examples and comparative examples. It is to be understood, however, that these examples are provided by way of illustration and nothing therein should be taken as a limitation upon the scope of the present invention.

### COMPARATIVE EXAMPLE 1

### Catalyst Preparation

1000 g of ammonium molybdenate was dissolved in 2500 ml of distilled water with stirring and heating at 70° C. to prepare solution (1). To 400 ml of distilled water, 228 g of bismuth nitrate, 190.70 g of iron nitrate and 1.71 g of potassium nitrate were added and mixed sufficiently, and then 71 g of nitric acid was added and dissolved in the mixture to prepare solution (2). 604.4 g of cobalt nitrate was dissolved in 200 ml of distilled water to prepare solution (3). The solution (1) was mixed with the solution (3) with vigorous stirring, to which the solution (2) was then added to prepare a catalyst suspension. The suspension was dried in an electric oven at 120° C. for 12 hours, followed by crushing into a size of less than 150 μm. The crushed catalyst powders were mixed for 2 hours, formed into a shape of pellet, and calcined at 450° C. for 5 hours under an air atmosphere, then examined for catalytic activities.

The prepared catalyst has the following composition:
Mo₁₂Bi₁Fe₁Co_{4.4}K_{0.036} (Catalyst 1)

### EXAMPLE 1

A catalyst was prepared in the same manner as in Comparative Example 1 except that 6% by weight of urea was further added before forming the crushed catalyst powders into a shape.

### EXAMPLE 2

A catalyst was prepared in the same manner as in Comparative Example 1 except that 8% by weight of urea was further added before forming the crushed catalyst powders into a shape.

### EXAMPLE 3

A catalyst was prepared in the same manner as in Comparative Example 1 except that 10% by weight of urea was further added before forming the crushed catalyst powders into a shape.

### EXAMPLE 4

A catalyst was prepared in the same manner as in Comparative Example 1 except that 12% by weight of urea was further added before forming the crushed catalyst powders into a shape.

### EXAMPLE 5

A catalyst was prepared in the same manner as in Comparative Example 1 except that 6% by weight of naphthalene was further added before forming the crushed catalyst powders into a shape.

### EXAMPLE 6

A catalyst was prepared in the same manner as in Comparative Example 1 except that 8% by weight of naphthalene was further added before forming the crushed catalyst powders into a shape.

### EXAMPLE 7

A catalyst was prepared in the same manner as in Comparative Example 1 except that 10% by weight of naphthalene was further added before forming the crushed catalyst powders into a shape.

### EXAMPLE 8

A catalyst was prepared in the same manner as in Comparative Example 1 except that 12% by weight of naphthalene was further added before forming the crushed catalyst powders into a shape.

### COMPARATIVE EXAMPLE 2

1000 g of ammonium molybdenate was dissolved in 2500 ml of distilled water with stirring and heating at 70° C. to prepare solution (1). To 400 ml of distilled water, 228 g of bismuth nitrate, 190.70 g of iron nitrate, 1.71 g of potassium nitrate and 62.25 g of aluminum chloride were added and mixed sufficiently, and then 71 g of nitric acid was added and dissolved in the mixture to prepare solution (2). 604.4 g of cobalt nitrate was dissolved in 200 ml of distilled water to prepare solution (3). The solution (1) was mixed with the solution (3) by vigorous stirring, to which the solution (2) was then added to prepare a catalyst suspension. The suspension was dried in an electric oven at 120° C. for 12 hours, followed by crushing into a size of less than 150 μm. The crushed catalyst powders were mixed for 2 hours, formed into a shape of pellet, and calcined at 450° C. for 5 hours under an air atmosphere, then examined for catalytic activities.

The prepared catalyst has the following composition:
Mo₁₂Bi₁Fe₁Co_{4.4}Al₁K_{0.036} (Catalyst 2)

### EXAMPLE 9

A catalyst was prepared in the same manner as in Comparative Example 2 except that 6% by weight of melamine was further added before forming the crushed catalyst powders into a shape.

### EXAMPLE 10

A catalyst was prepared in the, same manner as in Comparative Example 2 except that 8% by weight of melamine was further added before forming the crushed catalyst powders into a shape.

### EXAMPLE 11

A catalyst was prepared in the same manner as in Comparative Example 2 except that 10% by weight of melamine was further added before forming the crushed catalyst powders into a shape.

### EXAMPLE 12

A catalyst was prepared in the same manner as in Comparative Example 2 except that 12% by weight of melamine was further added before forming the crushed catalyst powders into a shape.

### COMPARATIVE EXAMPLE 3

1000 g of ammonium molybdenate was dissolved in 2500 ml of distilled water with stirring and heating at 70° C. to prepare solution (1). To 400 ml of distilled water, 228 g of bismuth nitrate, 190.70 g of iron nitrate, 15 g of cerium nitrate, 21 g of manganese nitrate and 1.71 g of potassium nitrate were added and mixed sufficiently, and then 71 g of nitric acid was added and dissolved in the mixture to prepare solution (2). 604.4 g of cobalt nitrate was dissolved in 200 ml of distilled water to prepare solution (3). The solution (1) was mixed with the solution (3) by vigorous stirring, to which the solution (2) was then added to prepare a catalyst suspension. The suspension was dried in an electric oven at 120° C. for 12 hours, followed by crushing into a size of less than 150 μm. The crushed catalyst powders were mixed for 2 hours, formed into a shape of pellet, and calcined at 450° C. for 5 hours under an air atmosphere, then examined for catalytic activities.

The prepared catalyst has the following composition:
Mo₁₂Bi₁Fe₁Co_{4.4}K_{0.036}Ce_{0.1}Mn_{0.1} (Catalyst 3)

### EXAMPLE 13

A catalyst was prepared in the same manner as in Comparative Example 3 except that 6% by weight of ammonium oxalate was further added before forming the crushed catalyst powders into a shape.

### EXAMPLE 14

A catalyst was prepared in the same manner as in Comparative Example 3 except that 8% by weight of ammonium oxalate was further added before forming the crushed catalyst powders into a shape.

### EXAMPLE 15

A catalyst was prepared in the same manner as in Comparative Example 3 except that 10% by weight of ammonium oxalate was further added before forming the crushed catalyst powders into a shape.

### EXAMPLE 16

A catalyst was prepared in the same manner as in Comparative Example 4 except that 12% by weight of ammonium oxalate was further added before forming the crushed catalyst powders into a shape.

### COMPARATIVE EXAMPLE 4

1000 g of ammonium molybdenate was dissolved in 2500 ml of distilled water with stirring and heating at 70° C. to prepare solution (1). To 400 ml of distilled water, 228 g of bismuth nitrate, 190.70 g of iron nitrate, 149 g of nickel nitrate and 1.71 g of potassium nitrate were added and mixed sufficiently, and then 71 g of nitric acid was added and dissolved in the mixture to prepare solution (2). 321.56 g of cobalt nitrate was dissolved in 200 ml of distilled water to prepare solution (3). The solution (1) was mixed with the solution (3) by stirring, to which the solution (2) was then added to prepare a catalyst suspension. The suspension was dried in an electric oven at 120° C. for 12 hours, followed by crushing into a size of less than 150 μm. The crushed catalyst powders were mixed for 2 hours, formed into a shape of pellet, and calcined at 450° C. for 5 hours under an air atmosphere, then examined for catalytic activities.

The prepared catalyst has the following composition:
Mo₁₂Bi₁Fe₁Co₃Ni_{1.4}K_{0.036} (Catalyst 4)

### EXAMPLE 17

A catalyst was prepared in the same manner as in Comparative Example 4 except that 6% by weight of methyl oxalate was further added before forming the crushed catalyst powders into a shape.

### EXAMPLE 18

A catalyst was prepared in the same manner as in Comparative Example 4 except that 8% by weight of methyl oxalate was further added before forming the crushed catalyst powders into a shape.

### EXAMPLE 19

A catalyst was prepared in the same manner as in Comparative Example 4 except that 10% by weight of methyl oxalate was further added before forming the crushed catalyst powders into a shape.

### EXAMPLE 20

A catalyst was prepared in the same manner as in Comparative Example 4 except that 12% by weight of methyl oxalate was further added before forming the crushed catalyst powders into a shape.

### TEST EXAMPLE

### Catalytic Activity Test

In order to measure the activity of the catalyst prepared according to the method of the present invention, the catalyst was formed into a pellet and placed into a reactor, and the oxidation of propylene was performed in the reactor to produce acrolein and acrylic acid. In the production of acrolein and acrylic acid, reaction gas comprising 1-10% by volume of propylene, 1-15% by volume of oxygen, 5-60% by volume of water vapor and 20-80% by volume of inert gas was introduced into the reactor and contacted the catalyst at a reaction temperature of 200-370° C. and a space velocity of 500-5000 hour (STP) under a reaction pressure of 0.5-3 atm. The reaction test results for the catalysts prepared in Examples and Comparative Examples are given in Table 1 below.

Conversion ratio, selectivity and yield given in Table 1 were calculated by the following equations 1, 2 and 3, respectively:
Propylene conversion (%)=(moles of reacted propylene/moles of fed propylene)×100 [Equation 1]
Acrolein selectivity (%)=(moles of produced acrolein/moles of reacted propylene)×100 [Equation 2]
Yield (%)=(moles of produced acrolein and acrylic acid/moles of fed propylene)×100 [Equation 3]

TABLE 1

| | | | Amount of | | | | Yield of |
|---|---|---|---|---|---|---|---|
| | | | catalyst | | Propylene | Acrolein | acrolein + |
| | Catalyst | Catalyst | additive | Reaction | conversion | selectivity | acrylic |
| | composition | additive | (wt %) | temp. | (%) | (%) | acid |
| Comp. | Mo₁₂Bi₁Fe₁CO_{4.4}K_{0.036} | — | 0 | 320 | 96.20 | 80.14 | 89.23 |
| Ex. 1 | | | | | | | |
| Ex. 1 | | Urea | 6 | 320 | 96.54 | 80.21 | 90.47 |
| Ex. 2 | | Urea | 8 | 320 | 97.60 | 80.01 | 90.68 |
| Ex. 3 | | Urea | 10 | 320 | 97.32 | 79.84 | 91.78 |
| Ex. 4 | | Urea | 12 | 320 | 97.35 | 79.64 | 91.13 |
| Ex. 5 | | Naphthalene | 6 | 320 | 96.34 | 82.41 | 92.89 |
| Ex. 6 | | Naphthalene | 8 | 320 | 97.78 | 81.45 | 91.60 |
| Ex. 7 | | Naphthalene | 10 | 320 | 98.45 | 79.16 | 92.78 |
| Ex. 8 | | Naphthalene | 12 | 320 | 98.57 | 79.24 | 91.19 |
| Comp. | Mo₁₂Bi₁Fe₁Co_{4.4}Al₁K_{0.036} | — | 0 | 320 | 96.14 | 81.60 | 89.18 |
| Ex. 2 | | | | | | | |
| Ex. 9 | | Melamine | 6 | 320 | 97.60 | 80.20 | 90.25 |
| Ex. 10 | | Melamine | 8 | 320 | 97.43 | 79.19 | 90.68 |
| Ex. 11 | | Melamine | 10 | 320 | 98.15 | 79.85 | 91.10 |
| Ex. 12 | | Melamine | 12 | 320 | 98.20 | 78.69 | 91.89 |
| Comp. | Mo₁₂Bi₁Fe₁CO_{4.4}K_{0.036}Ce_{0.1}Mn_{0.1} | — | 0 | 320 | 96.00 | 80.06 | 90.54 |
| Ex. 3 | | | | | | | |
| Ex. 13 | | Ammonium | 6 | 320 | 96.84 | 81.21 | 91.55 |
| | | oxalate | | | | | |
| Ex. 14 | | Ammonium | 8 | 320 | 96.41 | 81.07 | 92.65 |
| | | oxalate | | | | | |
| Ex. 15 | | Ammonium | 10 | 320 | 97.51 | 80.08 | 91.48 |
| | | oxalate | | | | | |
| Ex. 16 | | Ammonium | 12 | 320 | 97.34 | 79.45 | 91.66 |
| | | oxalate | | | | | |
| Comp. | Mo₁₂Bi₁Fe₁Co₃Ni_{1.4}K_{0.036} | — | 0 | 320 | 96.7 | 79.1 | 88.98 |
| Ex. 4 | | | | | | | |
| Ex. 17 | | Methyl oxalate | 6 | 320 | 97.4 | 80.64 | 90.81 |
| Ex. 18 | | Methyl oxalate | 8 | 320 | 97.4 | 80.54 | 91.56 |
| Ex. 19 | | Methyl oxalate | 10 | 320 | 98.35 | 79.15 | 90.79 |
| Ex. 20 | | Methyl oxalate | 12 | 320 | 97.35 | 79.56 | 91.21 |

As can be seen from the foregoing, the addition of a given amount of the sublimable material, such as urea (NH₂CONH₂), melamine (C₃H₆N₆), ammonium oxalate (C₂H₈N₂O₄), methyl oxalate (C₄H₆O₄) or naphthalene (C₁₀H₈), as a catalyst additive, produced many fine pores in the catalyst. Thus, the use of this catalyst in the vapor-phase oxidation of propylene resulted in an increase in propylene conversion, and an increase in the yield of acrolein and acrylic acid.

While this invention has been described in connection with what is presently considered to be the most practical and preferred embodiment, it is to be understood that the invention is not limited to the disclosed embodiment, but, on the contrary, it is intended to cover various modifications and variations within the spirit and scope of the appended claims.

1. A composition for catalyst preparation comprising:
1) a composite metal oxide as a catalytic active component; and
2) a catalyst additive selected from sublimable materials.

2. The composition of claim 1, which comprises:
1) a catalytic component represented by the following formula 1; and
2) a catalyst additive selected from sublimable materials:
MoₐBi_{b}A_{c}B_{d}CₑD_{f}E_{g}O_{g} [Formula 1]
wherein Mo is molybdenum;
Bi is bismuth;
A is an iron element;
B is at least one element selected from the group consisting of Co and Ni;
C is at least one element selected from the group consisting of W, Si, Al, Zr, Ti, Cr, Ag and Sn;
D is at least one element selected from the group consisting of P, Te, As, B, Sb, Ce, Nb, Pb, Mn, Zn and Nb;
E is at least one element selected from the group consisting of Na, K, Li, Rb, Cs, Ta, Ca and Mg;
a, b, c, d, e, f and g represent the atomic ratio of the respective elements, and
when a is 12, b is then 0.01-10, c is 0.01-10, d is 0.01-10, e is 0.01-10, f is 0.01-20 and g is 0.01-10, and h is a numeral value depending on the oxidation state of each of the elements.

3. The composition of claim 1, wherein the catalyst additive is at least one selected from the group consisting of urea (NH₂CONH₂), melamine (C₃H₆N₆), ammonium oxalate (C₂H₈N₂O₄), methyl oxalate (C₄H₆O₄) and naphthalene (C₁₀H₈).

4. The composition of claim l, wherein the catalyst additive is in the form of a granular powder with a size of 0.01-10 μm or a liquid.

5. The composition of claim 1, wherein the catalyst additive is added at the amount of 0.1-30% by weight to the weight of the catalytic active component of formula 1.

6. A method for preparing a catalyst containing a composite metal oxide as a catalytic active component, the method comprising the steps of:
a) prepring a catalyst suspension containing salt of each metal components of the composite metal oxide for the catalytic active component;
b) drying the catalyst suspension and then crushing the dried material to prepare a catalyst powder;
c) mixing the catalyst powder with a catalyst additive selected from sublimable materials; and
d) calcining the mixture from the step c).

7. The method of claim 6, which comprises the steps of:
a) preparing a catalyst suspension containing a catalytic active component represented by the following formula 1;
b) drying the catalyst suspension and then crushing the dried material into a catalyst powder with a particle size of less than 150;
c) mixing the crushed catalyst powder with a catalyst additive selected from sublimable materials; and
d) calcining the mixture from the step c) at a temperature of 400-500° C. under an air atmosphere for at least 5 hours:
MOₐBi_{b}A_{c}B_{d}CₑD_{f}E_{g}Oₕ [Formula 1]
wherein Mo is molybdenum;
Bi is bismuth; A is an iron element;
B is at least one element selected from the group consisting of Co and Ni;
C is at least one element selected from the group consisting of W, Si, Al, Zr, Ti, Cr, Ag and Sn;
D is at least one element selected from the group consisting of P, Te, As, B, Sb, Ce, Nb, Pb, Mn, Zn and Nb;
E is at least one element selected from the group consisting of Na, K, Li, Rb, Cs, Ta, Ca and Mg;
a, b, c, d, e, f and g represent the atomic ratio of the respective elements, and
when a is 12, b is then 0.01-10, c is 0.01-10, d is 0.01-10, e is 0.01-10, f is 0.01-20 and g is 0.01-10, and h is a numeral value depending on the oxidation state of each of the elements.

8. The method of claim 6, wherein the catalyst additive is at least one selected from the group consisting of urea (NH₂CONH₂), melamine (C₃H₆N₆), ammonium oxalate (C₂H₈N₂O₄), methyl oxalate (C₄H₆O₄) and naphthalene (C₁₀H₈).

9. The method of claim 7, which further comprises, between the steps b) and c), a step of calcining the crushed catalyst powder at a temperature of 180-250° C. for 3-5 hours under an oxygen atmosphere.

10. The method of claim 6, wherein the catalyst additive is in the form of a granular powder with a size of 0.01-10 μm or a liquid.

11. The method of claim 7, wherein the catalyst additive is added at the amount of 0.1-30% by weight to the weight of the catalytic active component of formula 1.

12. A catalyst having fine pores formed by removing the catalyst additive from the composition for catalyst preparation according to claim 1 by a calcining process.
